(19) United States
(12) Patent Application Publication
(10) Pub. No.: US 2009/0049746 A1
(43) Pub. Date: Feb. 26, 2009

(54) Method for training ornamental trees

(75) Inventor: Robert E. Douglass, Beavercreek, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(73) Assignee: Sweetheart Nursery, Inc.

(21) Appl. No.: 11/895,001

(22) Filed: Aug. 21, 2007

(51) Int. Cl. A01G 1/00

(52) U.S. Cl. 47/58.1 R

(57) ABSTRACT

A plant is trained to provide a trunk having an ornamental shape by causing a pair of shoots to develop on opposed sides of the trunk. As the shoots grow they are attached to a form having the desired ornamental shape. When the shoots meet at the upper end of the form, they are attached to one another to form a continuation of the trunk. Top growth is then allowed to grow on the trunk above the form.

### BACKGROUND OF THE INVENTION

It is common to form plants into the shape of common objects. The most popular way of accomplishing this is to prune a shrub to achieve the desired shape, as is done with topiaries. However, topiaries have limited appeal since they need to be pruned continually to maintain the desired shape.

### BRIEF SUMMARY OF THE INVENTION

The subject invention provides a method for training a plant to have an ornamental shape by causing a pair of shoots to develop on opposed sides of a trunk. As the shoots grow they are attached to a form which has the desired ornamental shape. When the shoots reach the top of the form they are connected to create a continuation of the trunk above the form. Top growth is then allowed to develop on the trunk above the form.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIGS. 1-4 are side elevation views showing the various steps in the method of the subject invention.

FIG. 5 is an elevation view, similar to FIG. 1, showing an alternative embodiment of the invention.

FIG. 6 is a side elevation view, similar to FIG. 1, showing another embodiment of the invention.

FIGS. 7 and 8 are side elevation views showing yet another embodiment of the invention.

FIG. 9 is a side elevation view showing still another embodiment of the invention.

### DETAILED DESCRIPTION OF PREFERRED EMBODIMENT

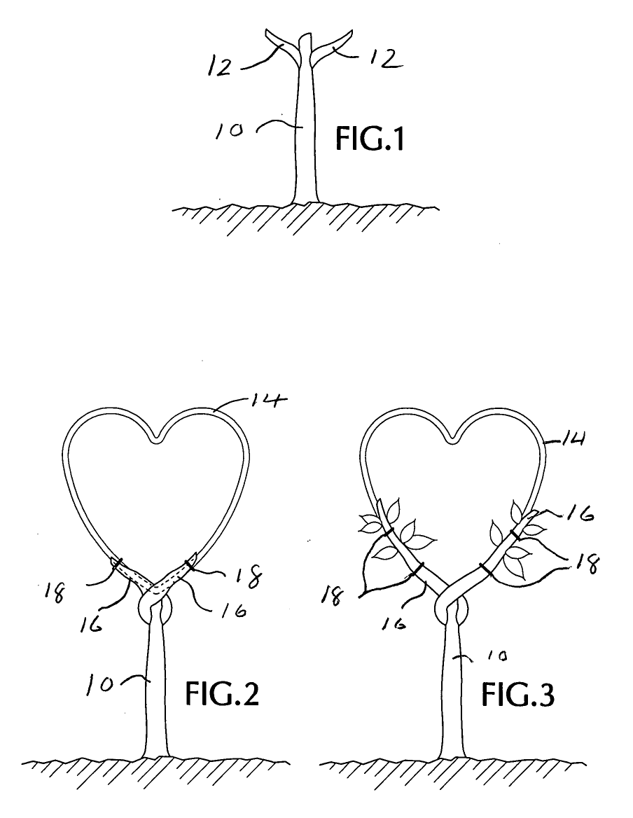

Referring to the drawings, a plant is trained according to the subject intervention by allowing a trunk 10 to grow to a desired height and girth. Buds 12 are then allowed to develop on opposite sides of the trunk. For plants that naturally have opposed buds, this can be accomplished merely by cutting the trunk 10 slightly above a pair of buds, FIG. 1. For plants that have asymmetric buds, the trunk 10 is cut slightly above a bud 12a on one side of the trunk and a second bud 12b is grafted onto the trunk across from the bud 12a, FIG. 5. To ensure that the buds are located at the desired height on the trunk, buds 12c could be grafted on both sides of the trunk 10, FIG. 6.

An open centered form 14, made from wire, plastic or similar material, is attached to the trunk above the buds 12 by suitable means. The form shown in the drawings creates the outline of the heart but it could have any desired shape. It could be either symmetrical, as is the case with the heart, or asymmetrical depending on the desired effect. As shoots 16 start to form from the buds 12, FIG. 2, they preferably are first crossed over one another left to right and then they are secured to the form. As the shoots 16 continue to grow, they are secured to the form at spaced-apart intervals, FIG. 3. The shoots can be attached to the form by any conventional means, such as plastic tape 18 commonly used in the nursery industry to tie plants to stakes, twine or any similar material.

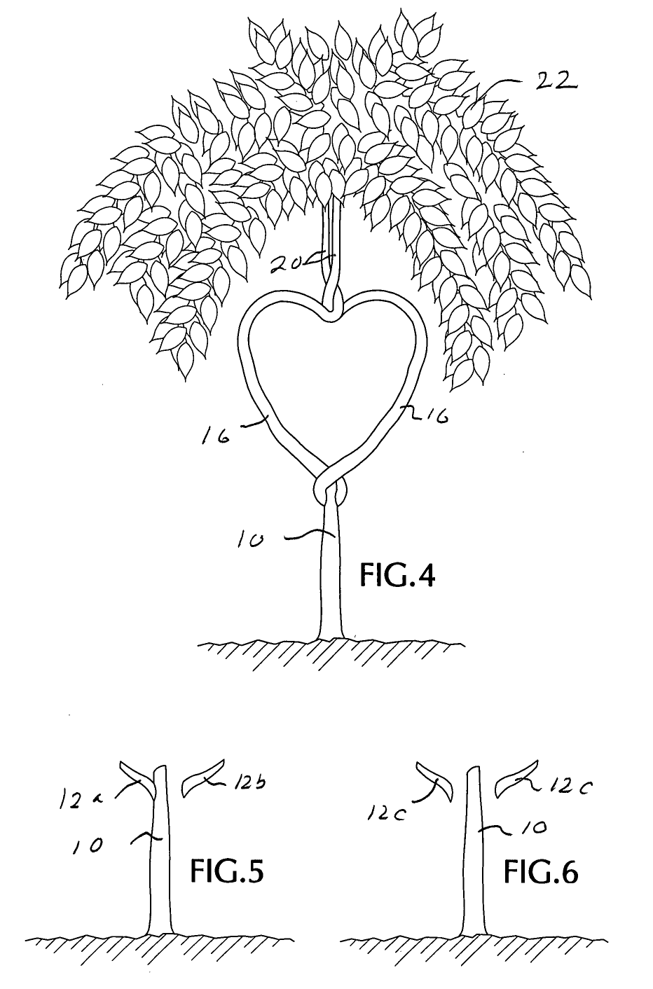

When the shoots reach the top of the form, they preferably are wrapped around one another and the two shoots are allowed to continue to grow upwardly as double shoots 20 until they reach the desired height, and top growth 22 normal to that variety is allowed to grow from there, FIG. 4. The shoots 16 and 2 then become part of the plant's trunk. Once the top growth is established all foliage or branches are removed from this trunk. The form can be removed or left in place as desired.

The purpose for crossing the shoots at the bottom of the form is to not form a V-notch which would allow one side to easily be split off of the other side. The purpose of wrapping the shoots around one another at the top of the form is to ensure that the trunk remains in the shape created by the form and that the trunk pieces 20 do not separate from one another due to the weight of the top growth and the effect of wind. To this end, the two trunk pieces 20 can also be tied together (not shown), if desired. While the form can be almost any shape, its sides must be far enough apart that they do not grow together over time as the girth of the trunk increases. This typically requires that the sides of the form be at least 2½ to 3 feet apart. When multiple plants are being grown for resale, it may be desirable to allow more than one bud set to form and then use the set that grows more vigorously.

The method works best with ornamental trees that naturally form a canopy on top of a vertical trunk, such as flowering fruit trees, Japanese maples, and similar trees commonly used for landscape purposes. However, referring to FIG. 9, trees which normally have multiple trunks can be allowed to grow several trunks 10a. Forms can be attached to each trunk and multiple shaped trunks 24 can be formed by the same method used to form shapes in a single trunk, as described above.

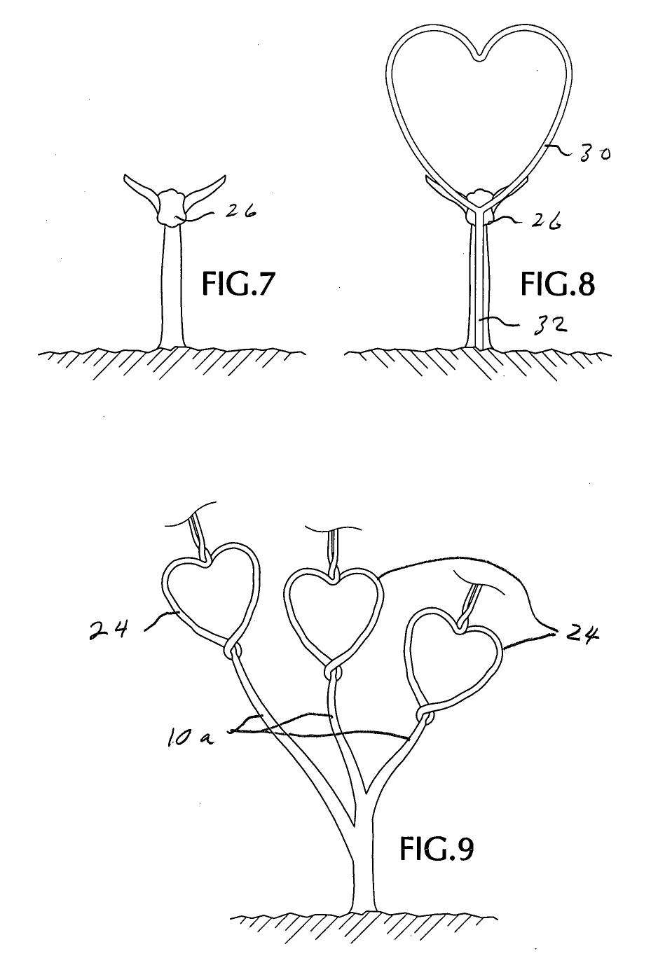

Referring now to FIGS. 7 and 8, plants that grow stems from a bud union 26, such as tree roses, can have two stems chosen to form shoots 28 that are trained in essentially the same manner as described above. In the case of tree roses, the form 30 is attached to the stake 32 that is normally used to support the plant. With tree roses, additional sprouts from the bud union need to be removed on a continuous basis.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A method for training a plant comprising:
(a) causing a pair of buds located on opposed sides of a trunk to develop into shoots;
(b) attaching said shoots to opposite sides of a form at spaced intervals as said shoots grow; and
(c) connecting said shoots to one another at an upper end of said form to form an integral trunk above said form.

2. The method of claim 1 including the further step of crossing said shoots over one another before they are attached to said form so that each shoot grows along the side of the form opposite the side it developed on.

3. The method of claim 1 wherein said shoots are connected at the top of said form by wrapping them around one another.

4. The method of claim 1 wherein both of said shoots develop from naturally occurring opposed buds.

5. The method of claim 1 wherein one of said shoots develops from a naturally occurring bud and the other one of said shoots develops from a grafted bud.

6. The method of claim 1 wherein both of said shoots develop from grafted buds.

7. The method of claim 1 wherein said shoots are tied to said form.

8. The method of claim 1 wherein said form is supported solely by said plant.

9. The method of claim 1 wherein said form is attached to a stake which helps support said plant.

10. The method of claim 1 wherein said plant is a tree rose.

11. The method of claim 1 wherein said shoots are caused to develop on a single trunk.

12. The method of claim 1 wherein said shoots are caused to develop on multiple trunks and the shoots on each trunk are attached to unique form.

13. The method of claim 10 wherein said shoots grow out of a bud union located at the top of a root stock.
